(19) United States
(12) Patent Application Publication
(10) Pub. No.: US 2010/0255268 A1
(43) Pub. Date: Oct. 7, 2010

(54) COMPOSITION FOR MOLD SHEET AND METHOD FOR PREPARING MOLD SHEET USING SAME

(75) Inventors: Se Jin Choi, Yongin-si (KR); Tae Wan Kim, Seongnam-si (KR); Seung Joon Baek, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: MINUTA TECHNOLOGY, Gyeonggi-do (KR)

(21) Appl. No.: 12/743,322

(22) PCT Filed: Nov. 10, 2008
(86) PCT No.: PCT/KR08/06608

§ 371 Date: May 17, 2010

(30) Foreign Application Priority Data
Nov. 22, 2007 (KR) 10-2007-0119763

(51) Int. Cl. B32B 3/10; H05H 1/00; B29C 35/08; B32B 37/00

(52) U.S. Cl. 428/195.1; 264/483; 264/494; 156/242

(57) ABSTRACT

The present invention relates to a mold sheet composition for forming patterns, which comprises (A) an active energy ray-curable compound having one or more unsaturated double bond, and (B) 0.1 to 20 parts by weight of a photo-initiator based on 100 parts by weight of the component (A); and a mold sheet for forming patterns, which comprises the active energy curable compound of the composition, and has an intaglio of the desired pattern thereon.

### FIELD OF THE INVENTION

The present invention relates to a composition for preparing a mold sheet used in forming hyperfine patterns on a substrate, and a method for preparing the mold sheet therefrom.

### BACKGROUND OF THE INVENTION

Various devices including semiconductor, electronic, photoelectric, magnetic, display, and microelectromechanical devices as well as optical lens (e.g., prism sheet and lenticular lens sheet) comprise components having micro patterns, and they have been conventionally formed by photolithography. In the photolithographic method, however, the circuit line-width or the pattern line-width is dependent on the bandwidth of the light used in the exposure process. Therefore, it is very difficult to form a hyperfine pattern having a line-width below 100 nm on a substrate. Further, such a conventional photolithographic method requires various steps (such as substrate cleaning, substrate surface treatment, photosensitive polymer coating treatment at a low temperature, exposure, developing, cleaning, high temperature heat treatment and others), which makes the photolithographic method complex and costly.

To overcome the limits of the conventional photolithographic method, there has recently been developed a nano-imprint lithographic method for transferring a pattern of a hard mold to a polymer thin film substrate by preparing a hard mold made of silicon (Si) having a desired pattern, comprising the steps of coating the surface of the hard mold with a thermoplastic polymer thin film, compressing the coated hard mold under a high temperature-high pressure condition with a plate press, and separating the compressed mold from the substrate. Such a nano-imprint lithographic method has an advantage in that a hyperfine pattern can be easily formed. The line width resolution of the pattern has been determined to be as small as about 7 nm (See S. Y. Chou et al., J. Vac. Sci. Technol. B15, 2897 (1997)).

Such nano-imprint lithography still has drawbacks in that it is difficult to separate the mold from the substrate after the compression, and the high pressure-compression step tends to damage the mold and the substrate. Moreover, since the patterning is performed by taking advantage of the fluidity of a polymer heated to a high temperature, a considerable time is required to carry out such patterning.

Other examples of non-conventional lithographic methods include micro-contact printing (μCP), micro-molding in capillaries (MIMIC), micro-transfer molding (μTM), soft molding, and capillary force lithography (CFL). Used in these methods as a mold is a polymer elastomer such as polydimethylsiloxane (PDMS). A PDMS mold used in the nano-imprint lithography has a lower surface energy, low adhesive force to the surface of other material, which enables easy separation of the PDMS mold from the surface of a substrate after the patterning. Such elastomer PDMS mold, however, has a low mechanical strength and tends to deform under certain conditions, and accordingly a PDMS mold cannot be used to form a micro pattern having a pattern resolution line smaller than about 500 μm which is dependent on the aspect ratio of the pattern to be formed. In addition, a PDMS mold swells and deforms when in contact with an organic solvent such as toluene, which limits the selection of the solvent usable in the patterning step.

### SUMMARY OF THE INVENTION

Accordingly, it is an object of the present invention to provide a mold sheet, which can be easily separated from a substrate, maintains its flexibility and mechanical strength, and does not swell when in contact with an organic solvent.

In accordance with one aspect of the present invention, there is provided a mold sheet composition for forming patterns, which comprises:

(A) an active energy ray-curable compound having one or more unsaturated double bond; and

(B) 0.1 to 20 parts by weight of a photo-initiator based on 100 parts by weight of the component (A).

In accordance with another aspect of the present invention, there is provided a mold sheet for forming a desired pattern comprising a cured product of the composition having an intaglio of the desired pattern formed thereon.

In accordance with further another aspect of the present invention, there is provided a method for preparing the mold sheet for forming a desired pattern, which comprises the steps of:

(A) coating or casting the composition on a mastermold having the desired pattern;

(B) curing the composition by irradiating an active energy ray thereon; and

(C) lifting off the cured product from the mastermold to obtain the mold sheet having an intaglio pattern of the desired pattern.

### BRIEF DESCRIPTION OF DRAWINGS

The above and other objects and features of the present invention will become apparent from the following description of the invention taken in conjunction with the following accompanying drawings, which respectively show:

FIG. 1a: a cross sectional photograph of a mold pattern after 300 m patterning process by using the mold sheet prepared in Preparation Example 1;

FIG. 1b: a cross sectional photograph of a mold pattern after 300 m patterning process by using the mold sheet prepared in Preparation Example 3;

FIG. 2a: a photograph showing the result of peel test of the mold sheet prepared in Preparation Example 2; and

FIG. 2b: a photograph showing the result of peel test of the mold sheet prepared in Preparation Example 4.

### DETAILED DESCRIPTION OF THE INVENTION

The mold sheet composition of the present invention comprises (A) 100 parts by weight of an energy ray-curable compound having one or more unsaturated double bond and (B) 0.1 to 20 parts by weight of a photo-initiator based on 100 parts by weight on the base of the component (A).

The active energy ray-curable compound having one or more unsaturated double bond (component (A)) may be at least one monomer having a functional group selected from the group consisting of vinyl, (meth)acryloxy and allyl, which can be cured when exposed to an active energy ray such as a ultra-violet ray, infrared ray and electron beam.

The monomer having a vinyl group may be cyclohexyl vinylether, 2-ethylhexyl vinylether, dodecyl vinyl ether, 1,4-butandiol divinylether, 1,6-hexanediol divinylether, diethyleneglycol divinylether, ethyleneglycol butyl vinylether, ethyleneglycol divinylether, triethyleneglycol methyl vinylether, triethyleneglycol divinylether, trimethylolpropane trivinylether, 1,4-cyclohexane dimethanol divinylether, vinylacetate, vinylchloroacetate, N-vinylpyrrolidone, N-vinylcarbazole, N-vinylcaprolactam, vinyltoluene, styrene, alphamethylstyrene, or a mixture thereof.

The monomer having a (meth)acryloxy group may be isobonyl acrylate, 1,6-hexanediol diacrylate, triethyleneglycol di(meth)acrylate, trimethylolpropane triacrylate, tetraethyleneglycol di(meth)acrylate, 1,3-butanediol diacrylate, 1,4-butanediol diacrylate, diethyleneglycol diacrylate, neopentylglycol diacrylate, neopentyl di(meth)acrylate, polyethyleneglycol di(meth)acrylate, pentaerythritol triacrylate, dipentaerythritol(hydroxy)penta acrylate, alkoxylated tetraacrylate, octyldecyl acrylate, isodecyl acrylate, lauryl acrylate, stearyl acrylate, behenyl acrylate, or a mixture thereof.

Further, the monomer having an allyl group may be allyl propylether, allyl butylether, allyl ether, pentaerythritol triallylether, diphenic acid diallyl, trimethylolpropane diallylether, trimethylolpropane triallylether, diallylphthalate, diallylisophthalate, triallyl trimeritate, or a mixture thereof.

The photo-initiator preferably used in the present invention is a compound which produces free radicals or cations when treated with an active energy ray. Representative examples of the free radical initiator include benzyl ketals, benzoin ethers, acetophenone derivatives, ketoxime ethers, benzophenone, benzo and thioxanthone compounds, and a mixture thereof, which examples of the cationic initiator that may be used in the present invention are onium salts, ferrocenium salts, diazonium salts, or a mixture thereof.

In one preferred embodiment, the inventive mold sheet composition may further comprise a compound having one or more functional groups containing silicon, fluorine, or both in an amount of 0.01 to 200, preferably 0.1 to 100, more preferably 0.1 to 50 parts by weight based on 100 parts by weight of the component (A) in order to enhance the releasing property.

The compound having functional groups containing silicon, fluorine, or both is also an active energy ray-curable compound, and it may be derived from a vinyl resin, (meth)acryloxy or allyl resin, surfactant, oil, and a mixture thereof. Representative examples thereof include silicon-containing vinyl derivatives, silicon-containing (meth)acrylates, (meth)acryloxy-containing organosiloxanes, silicon polyacrylates, fluoroalkyl-containing vinyl derivatives, fluoroalkyl-containing (meth)acrylates, fluorineated polyacrylates, polydimethylsiloxanes, fluorinated polymers, dimethyl silicon oil, and a mixture thereof.

In another preferred embodiment, the inventive mold sheet composition may further comprise an active energy ray-curable resin having at least one functional group selected from vinyl, (meth)acryloxy, allyl and allyloxy in an amount of 50 or less parts by weight based on 100 parts by weight of the component (A).

The active energy ray-curable resin is an oligomer or polymer having a molecular weight of 400 or more, and representative examples thereof include cycloaliphatic or aromatic urethane-based oligomer having at least one reactive group, polyester(meth)acylate, polyether(meth)acrylate, epoxy(meth)acrylate or polycarbonate(meth)acrylate oligomer, and a mixture thereof.

The active energy ray-curable resin may be preferably employed in an amount of 50 or less parts by weight based on 100 parts by weight of the component (A). When the amount is more than the limit, the thickness of the cured film becomes lower, the glass transition temperature (Tg) of the cured mold declines, and it tends to lower the heat resistance. Further, the resistance against chemicals and moisture becomes lower, and the durability during the repeated use in the patterning process also becomes lower.

In the present invention, a mold sheet for forming a pattern having an intaglio of the desired pattern thereon can be prepared by using the inventive composition.

Such a method for preparing the mold sheet for forming a desired patter, which comprises the steps of:

(A) coating or casting the inventive composition on the face of a mastermold having a desired pattern;

(B) curing the composition by irradiating an active energy ray thereon; and

(C) lifting off the cured product from the mastermold to obtain the mold sheet having an intaglio pattern of the desired pattern. The specific process to prepare the mold sheet using the curable composition can refer to Korea Patent No. 568581.

In accordance with another embodiment of the invention, the inventive mold sheet prepared by using the inventive composition has a structure wherein the cured material of the inventive composition is supported by a support. The method for preparing the mold sheet having the support further comprise the step of laminating a support on the composition coated or casted on a mastermold before conducting step (B).

In accordance with a still another embodiment of the present invention, the inventive method further comprises the step of coating or casting a second active energy ray-curable resin, before or after conducting step (B).

Further, the inventive method may further comprise the step of subjecting the product obtained from step (C) to a surface treatment.

Further, the inventive method may further comprise the step of subjecting the product obtained from step (C) to chemical surface treatment by using at least one alkoxy compound having one or more functional group selected from the group consisting of fluorine, silicon, alkyl, benzyl, and chloride.

In accordance with a still further embodiment of the present invention, the product obtained by separating from the mastermold may be adhered or compressed to a soft or hard support to obtain a multilayered product.

Unlike the known inorganic mold used in the imprint method, or elastomer heat-curable polymer used in the micro contact printing or soft molding method, the inventive mold sheet composition is characterized by using an active energy ray-curable compound, and it can be beneficially used in forming an ultra micro- or submicro-pattern having a line width of below several ten nm.

Further, the inventive mold sheet composition can provide a mold having a large size using a simple process at a low production cost, and therefore, it can be utilized for the mass production of an organic mold.

The inventive mold sheet may be applied to the methods known in the art (e.g., nano-imprint lithography using hard mold, or micro contact printing (μCP), micro-molding in capillaries (MIMIC), micro-transfer molding (μTM), soft molding or capillary force lithography (CFL) using an elastomer mold such as PDMS), and it may also be used in place of a metal mold in the conventional pattern forming process which uses an active energy ray-curable compound and a metal mold.

The mold thus fabricated may be further provide with a backing by combining with a soft or hard support having a desired shape (flat or curved) to obtain a multi-layered mold.

The inventive polymer mold can be applied for micro patterning methods such as printing (μCP), soft molding and capillary force lithography methods. Further, an active energy curable resin having fluidity may be brought into contact with the mold, which is then treated with an active energy ray such as UV to obtain a desired polymer micro pattern.

The following Examples are intended to further illustrate the present invention without limiting its scope.

TABLE 1

| | | | | Comp. | Comp. |
|---|---|---|---|---|---|
| Component | Ingredient | Ex. 1 | Ex. 2 | Ex. 1 | Ex. 2 |
| Active energy ray- | Trifunctional acrylate monomer | 50 | 50 | 0 | 50 |
| curable compound | (trimethylolpropane triacrylate) | | | | |
| | Hexafuctional acrylate monomer | 30 | 30 | 0 | 30 |
| | (dipentaerythrythol hexaacrylate) | | | | |
| | Difunctional acrylate monomer | 20 | 20 | 0 | 20 |
| | (1,6-hexanediol diacrylate) | | | | |
| Photo-initiator | 1-hydrocyclohexyl phenyl ketone | 5 | 5 | 5 | 5 |
| Active energy ray- | Urethane acrylate oligomer | 0 | 35 | 35 | 70 |
| curable resin | (difunctional; M.W: 5,000) | | | | |
| | Epoxy acrylate oligomer | 0 | 0 | 65 | 0 |
| | (monofunctional; M.W: 500) | | | | |
| | Polyester acrylate oligomer | 0 | 10 | 0 | 10 |
| | (tetrafunctional; M.W: 1,400) | | | | |
| Releasing agent | Organo-modified silicone | 6 | 6 | 6 | 6 |
| | acrylate | | | | |
| | Organo-modified polysiloxane | 2 | 2 | 2 | 2 |
| | Nonionic Perfluorobutane | 1 | 1 | 1 | 1 |
| | sulfonyl compounds | | | | |

### Preparation Example 1

A mold composition having the components listed in Example 1 of Table 1 was coated on the patterned face of a mastermold having a prism-pattern. Then, a transparent polyester sheet was laid on the coated surface, and the resulting laminate was irradiated with a UV light at 150 mJ/cm² to cure the resin composition, and the cured mold was lifted off from the mastermold to obtain a prism-patterned mold sheet having a thickness of 37 μm. Further, the prism-patterned face of the mold sheet was further irradiated with a UV light at 30,000 mJ/cm² using a high pressure mercury lamp to obtain a cured mold sheet for forming a prism pattern.

### Preparation Example 2

The procedure of Preparation Example 1 was repeated except for using the composition having the components listed in Example 2 of Table 1 to obtain a mold sheet for forming a prism pattern.

### Preparation Example 3

The procedure of Preparation Example 1 was repeated except for using the composition having the components listed in Comparative Example 1 of Table 1 to obtain a mold sheet for forming a prism pattern.

### Preparation Example 4

The procedure of Preparation Example 1 was repeated except for using the composition having the components listed in Comparative Example 2 of Table 1 to obtain a mold sheet for forming a prism pattern.

### Test Example 1

A transparent polyethylene terephthalate film was coated with an UV-curable resin for pattern forming, each of the mold sheets prepared in Preparation Examples 1 and 3 was laid on the coated surface, and the resulting laminate was repeatedly irradiated with a UV light at 250 mJ/cm² while maintaining the pressure-contact to obtain a prism sheet.

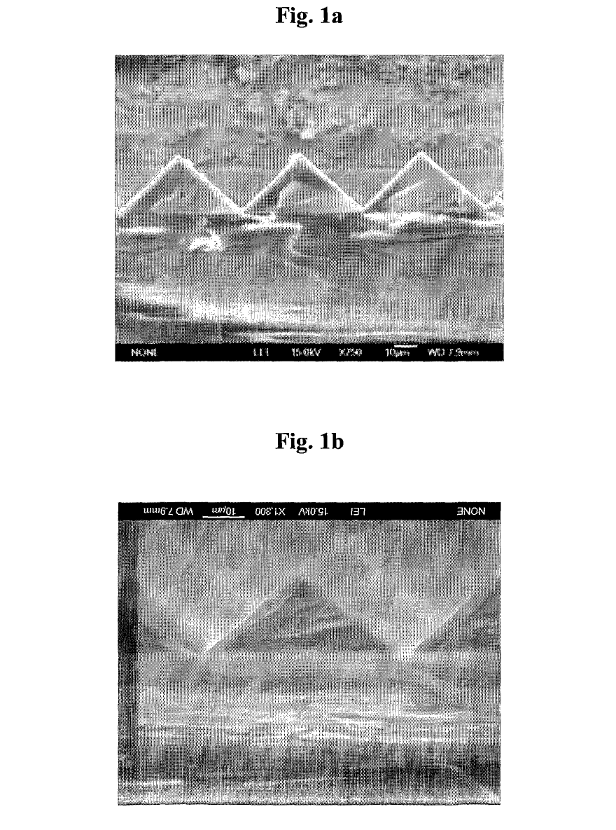

FIG. 1a shows a cross section of the patterned sheet obtained using the mold sheet prepared in Preparation Example 1 which did not change when producing more than 600 m of the final prism sheet by repeatedly using a mold sheet under the same conditions, the brightness of the final prism sheet remaining the same within 1% (FIG. 1a). However, the pattern configuration of the mold sheet preparing the mold sheet of Preparation Example 3 started to change from about 300 m point of the production, and the brightness decrease of the final prism sheet was over 5% (FIG. 1b).

### Test Example 2

The mold sheets prepared in Preparation Examples 2 and 4 were exposed to high-temperature steam for 10 min, and the patterns formed on the surface of the mold sheets were cross cut in the form of a chess board, an adhesive tape was attached thereon, and the tape was lifted off.

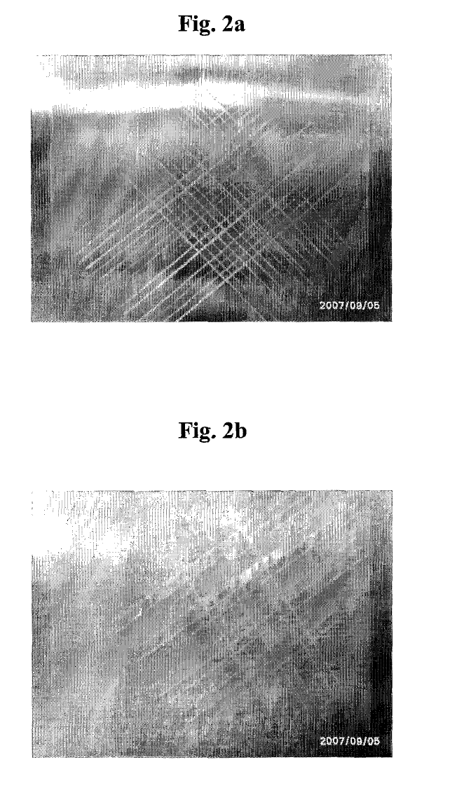

As shown in FIGS. 2a and 2b, only 5% of the pattern was lifted off from the polyester based mold sheet prepared in Preparation Example 2 (FIG. 2a), while more than 50% of the patterns was lifted off from the mold sheet prepared in Preparation Example 4 (FIG. 2b).

While the invention has been described with respect to the above specific embodiments, it should be recognized that various modifications and changes may be made and also fall within the scope of the invention as defined by the claims that follow.

1-18. (canceled)

19. A mold sheet having an intaglio of a desired pattern for transferring the desired pattern to another resin layer, the mold sheet comprising a cured product of a composition comprising:
(A) an active energy ray-curable compound having one or more unsaturated double bond;
(B) 0.1 to 20 parts by weight of a photo-initiator based on 100 parts by weight of the component (A); and
(C) 0.01 to 200 parts by weight of a compound containing silicon, based on 100 parts by weight of the component (A),
wherein the cured product is subjected to a surface treatment by using an active energy ray, ultra-violet ray, ozone or a plasma after curing the composition.

20. The mold sheet of claim 19, wherein the component (A) is at least one monomer having a functional group selected from the group consisting of vinyl, (meth)acryloxy and allyl.

21. The mold sheet of claim 19, wherein the photo-initiator is a compound capable of producing a free radical or cation when treated with an active energy ray.

22. The mold sheet of claim 19, which further comprises 0.01 to 200 parts by weight of a compound containing fluorine, based on 100 parts by weight of the component (A).

23. The mold sheet of claim 19, wherein the compound containing silicon is a resin, a surfactant, or an oil.

24. The mold sheet of claim 19, wherein the compound containing silicon is a resin derived from a vinyl resin, a (meth)acrylate resin or an allyl resin.

25. The mold sheet of claim 19, which further comprises 50 or less parts by weight of an active energy ray-curable resin comprising one or more functional groups selected from vinyl, (meth)acryloxy and allyl, based on 100 parts by weight of the component (A).

26. The mold sheet of claim 25, wherein the active energy ray-curable resin is an oligomer or polymer having a molecular weight of 400 or more.

27. The mold sheet of claim 19, wherein the cured product is laminated or attached with a support.

28. A method for preparing the mold sheet of claim 19, which comprises the steps of:
(A) coating or casting a composition on a mastermold having a desired pattern, the composition comprising (A) an active energy ray-curable compound having one or more unsaturated double bond, (B) 0.1 to 20 parts by weight of a photo-initiator based on 100 parts by weight of the component (A), and (C) 0.01 to 200 parts by weight of a compound containing silicon, based on 100 parts by weight of the component (A);
(B) curing the composition by irradiating an active energy ray thereon;
(C) lifting off the cured product from the mastermold to obtain the mold sheet having an intaglio pattern of the desired pattern; and
(D) subjecting the product obtained from step (C) to a surface treatment by using an active energy ray, ultra-violet ray, ozone or a plasma.

29. The method of claim 28, which further comprises the step of laminating a support on the composition coated or casted on the mastermold before curing step (B).

30. The method of claim 28, which further comprises the step of coating or casting a second active energy ray-curable resin before or after curing step (B).

31. The method of claim 28, which further comprises the step of subjecting the product obtained from step (D) to chemical surface treatment by using at least one alkoxy compound or chloride compound having one or more functional groups selected from the group consisting of fluorine, silicon, alkyl, and benzyl.

32. The method of claim 28, which further comprises the step of combining the product obtained from step (D) with a support.

33. The mold sheet of claim 22, wherein the compound containing fluorine is a resin, a surfactant, or an oil.

34. The mold sheet of claim 33, wherein the compound containing fluorine is a resin derived from a vinyl resin, a (meth)acrylate resin or an allyl resin.

35. The method of claim 29, which further comprises the step of combining the product obtained from step (D) with a support.

36. The method of claim 30, which further comprises the step of combining the product obtained from step (D) with a support.
